(19) United States
(12) Patent Application Publication
(10) Pub. No.: US 2008/0159320 A1
(43) Pub. Date: Jul. 3, 2008

(54) LAYER 3 SWITCH DEVICE AND ITS CONTROL METHOD

(76) Inventor: KAZUSHI KUBOTA, Tokyo (JP)

Correspondence Address: NEC CORPORATION OF AMERICA, 6535 N. STATE HWY 161, IRVING, TX, 75039, US

(21) Appl. No.: 11/958,742

(22) Filed: Dec. 18, 2007

(30) Foreign Application Priority Data
Dec. 27, 2006 (JP) 350806/2006

(51) Int. Cl. H04L 12/56

(52) U.S. Cl. 370/412

(57) ABSTRACT

A layer 3 switch device of a first packet system in which a first packet in the communication flow is sent via a packet transfer portion to a CPU for retrieving the header information, including a plurality of first shaper queues provided corresponding to a plurality of virtual routers and performing a flow rate control for the first packet from the packet transfer portion to the CPU, a second shaper queue for performing a flow rate control for the first packet of which the flow rate is controlled in the plurality of first shaper queues, and a control portion of dynamically controlling the flow rate for the second shaper queue into the CPU in accordance with a load state in the CPU.

This application is based upon and claims the benefit of priority from Japanese patent application No. 2006-350806 filed on Dec. 27, 2006, the disclosure of which is incorporated herein in its entirety by reference.

### BACKGROUND OF THE INVENTION

1. Field of the Invention

The present invention relates to a layer 3 switch device and a control method thereof, and more particularly to a layer 3 switch device of a first packet method and a control method thereof.

2. Related Art

Conventionally, in the layer 3 switch of the first packet system, an IP (Internet Protocol) packet transfer portion performs hardware transfer in the communication flow, whereby the IP packet transfer portion sends a first packet to a CPU (Central Processing Unit), and the CPU retrieves header information of the packet and performs a process for controlling the IP packet transfer portion to generate a cache entry in the communication flow in accordance with this retrieval result.

Therefore, in the layer 3 switch of the first packet system, it is always required that the first packet is sent from the IP packet transfer portion to the CPU. However, if the first packets are concentrated on the CPU, a congestion state (overload state) occurs in the CPU. Thus, it is required to control the flow of the first packet (flow rate control: shaping) so that the packet flow may not be concentrated on the CPU.

Therefore, in the layer 3 switch of the first packet system, a shaper queue 61 is provided to control the flow of the first packet to the CPU 4 within the IP packet transfer portion 6, as shown in FIG. 5.

Referring to FIG. 5, an interface unit 5 of the layer 3 switch comprises the IP packet transfer portion 6, a physical port 3, and the CPU 4. And a plurality of virtual routers VR#1 to VR#N (N is an integer of 2 or greater) are set up within this layer 3 switch.

The flow of each IP packet is shown as a first packet flow 161 of the virtual router VR#1, a first packet flow 162 of the virtual router VR#2 and a first packet flow 163 of the virtual router VR#N. All of the first packet flows 161 to 163 are inputted into the common shaper queue 61, which performs the shaping for controlling the flow rate of first packet to be led out to the CPU 4.

In FIG. 5, an unknown destination packet and a self node addressed packet, in addition to the first packet, are inputted into the shaper queue 61.

Such layer 3 switch was disclosed in Japanese Patent Laid-Open No. 2006-033714, Japanese Patent Laid-Open No. 2006-081057, Japanese Patent Laid-Open No. 2005-210556, Japanese Patent Laid-Open No. 2004-274441 and the like.

In the layer 3 switch of the first packet system as described above, the IP packet transfer portion 6 makes the flow rate control for the packet to the CPU 4. However, in a state where a plurality of virtual routers are set up within one device, when a large amount of first packets are sent from each virtual router, there is a problem that there is a bias in the first packet sending amount on each virtual router, and in an extreme case, some virtual routers can not send out the first packet at all.

In such flow rate control for the packet to the CPU, it is possible to make the flow rate control for the packet depending on a resource use state (load state) of the CPU, but since there is no check function for the virtual router of source, there is an unfair problem that there is a bias in the first packet sending amount on each virtual router, or some virtual routers (virtual router VR#N in FIG. 5) can not have the first packet accepted easily.

### SUMMARY

Thus, an exemplary object of the invention is to provide a layer 3 switch device that can send out the first packet to the CPU without a bias in the first packet sending amount on each virtual router while avoiding the congestion of the CPU, and a control method thereof.

A device of an exemplary aspect of the invention is a layer 3 switch device of a first packet system in which a first packet is sent via a packet transfer portion to header information retrieval portion of performing a retrieval process for the header information, including a plurality of first shaper queues provided corresponding to a plurality of virtual routers and performing a flow rate control for the first packet from the packet transfer portion to the header information retrieval portion, a second shaper queue for performing a flow rate control for the first packet of which the flow rate is controlled in the plurality of first shaper queues, and control portion of dynamically controlling the flow rate of packet from the second shaper queue to the header information retrieval portion in accordance with a load state in the header information retrieval portion.

A method of an exemplary aspect of the invention is a control method for a layer 3 switch device of a first packet system in which a first packet is sent via a packet transfer portion to header information retrieval portion of performing a retrieval process for the header information, including: performing a flow rate control for the first packet from the packet transfer portion to the header information retrieval portion with a plurality of first shaper queues provided corresponding to a plurality of virtual routers, performing a flow rate control for the first packet of which the flow rate is controlled in the plurality of first shaper queues using a second shaper queue, and dynamically controlling the flow rate of packet from the second shaper queue to the header information retrieval portion in accordance with a load state in the header information retrieval portion.

### BRIEF DESCRIPTION OF THE DRAWINGS

FIG. 1 is a functional block diagram of first exemplary embodiment of the present invention;

FIG. 2 is a state transition diagram showing a state transition of the second shaper queue as shown in FIG. 1;

FIG. 3 is a functional block diagram of second exemplary embodiment of the invention;

FIG. 4 is a view showing a state of the shaper queues inside the layer 3 switch as shown in FIG. 3 and a flow state of the IP packets; and

FIG. 5 is a functional block diagram showing the configuration of the interface unit for the layer 3 switch in the related art.

### EXEMPLARY EMBODIMENT

The exemplary embodiments of the present invention will be described below firstly from the principle of the invention. That is, in a layer 3 switch device according to the invention, a first shaper queue assigned to each virtual router controls the flow rate of the first packet addressed to a CPU from each virtual router, and a second shaper queue dynamically controls the inflow rate (total inflow band) of the first packet, of which the flow rate is controlled for each virtual router, addressed to the CPU, based on a CPU resource use state. Thereby, it is possible to reduce a bias (unfairness) in the first packet sending amount for each virtual router, while avoiding the congestion (overload) state of the CPU.

The embodiments of the invention will be described below with reference to the drawings.

### First Exemplary Embodiment

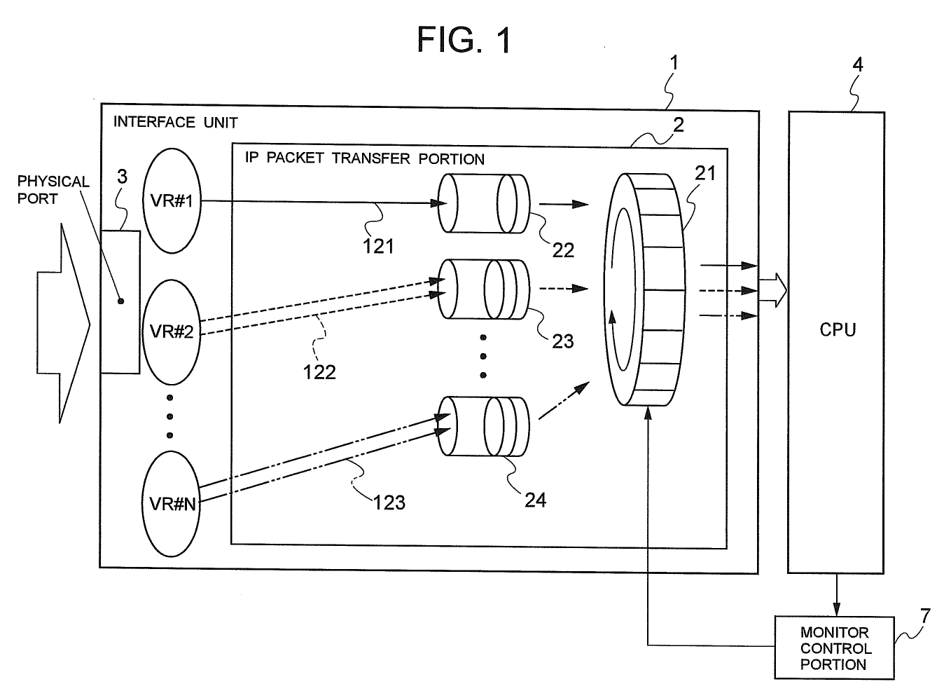

FIG. 1 is a block diagram showing the configuration of an interface unit for a layer 3 switch according to the first exemplary embodiment of the invention. In FIG. 1, the state of the first shaper queues inside the layer 3 switch of a first packet method according to the first embodiment of the invention and the flow state of the IP packets are also shown.

In FIG. 1, the layer 3 switch according to the embodiment of the invention comprises an interface unit 1, a CPU 4, and a monitor control portion 7 for monitoring a use state (hereinafter simply referred to as a CPU use state, also a load state) of resources in the CPU 4 and performing the flow rate control for a second shaper queue 21 within an IP packet transfer portion 2 based on this monitor result. And for this layer 3 switch, the virtual routers VR#1 to VR#N are set up.

Herein, the CPU 4 performs a process for receiving a first packet in the communication flow from the IP packet transfer portion 2, retrieving the header information of this first packet, and controlling the IP packet transfer portion 2 to generate a cache entry in the communication flow in accordance with this retrieval result, as previously described.

Specifically, the CPU 4 retrieves the header information of the first packet, and controls the IP packet transfer portion 2 to generate a cache entry in the communication flow, based on an IP address (destination and source) and a protocol type of the communication flow included in this header information.

The IP packet transfer portion 2 performs the hardware transfer for packets following the first packet (second packet, third packet and so on) based on the created cache entry in the communication flow. The cache entry in the communication flow means the information concerning what process (including a transfer process) the device performs for the communication flow, temporarily written in a memory, and is well known and not detailed.

The interface unit 1 comprises an IP packet transfer portion 2, and a physical port 3. The IP packet transfer portion 2 comprises the first shaper queues 22 to 24, provided (assigned) corresponding to the virtual routers VR#1 to VR#N, for controlling the flow rate of the first packet addressed to the CPU 4 for each of the virtual routers VR#1 to VR#N, and a second shaper queue 21 for controlling the flow rate of the first packet supplied from the first shaper queues 22 to 24.

A monitor control portion 7 controls the flow rate for the second shaper queue 21. That is, the monitor control portion 7 monitors the resource use state of the CPU 4, and dynamically controls the inflow rate of the first packet addressed to the CPU 4 from the second shaper queue 21, based on this monitor result.

The flow of each IP packet is a first packet flow 121 of the virtual router VR#1, a first packet flow 122 of the virtual router VR#2, or a first packet flow 123 of the virtual router VR#N. The queues of the virtual routers VR#1 to VR#N include a first shaper queue 22 of the virtual router VR#1, a first shaper queue 23 of the virtual router VR#2 and a first shaper queue 24 of the virtual router VR#N.

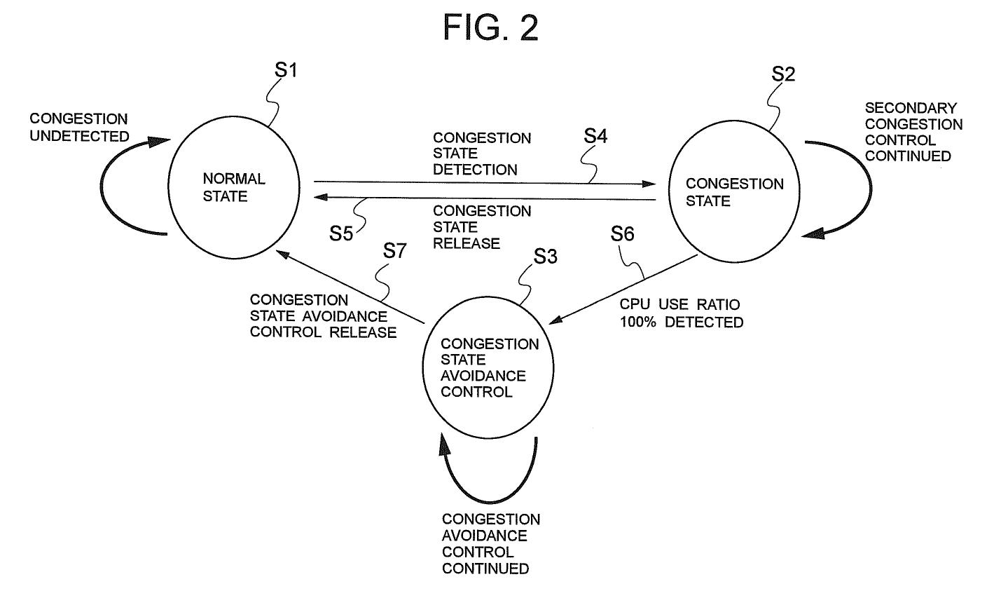

FIG. 2 is a diagram showing a state transition of the second shaper queue 21 as shown in FIG. 1. In FIG. 2, a normal state S1 is a state where the CPU use ratio is less than N % (N<100%), a congestion state S2 is a state where the CPU use ratio is greater than or equal to N %, and a congestion state avoidance control state S3 is a state after the CPU use ratio becomes 100%.

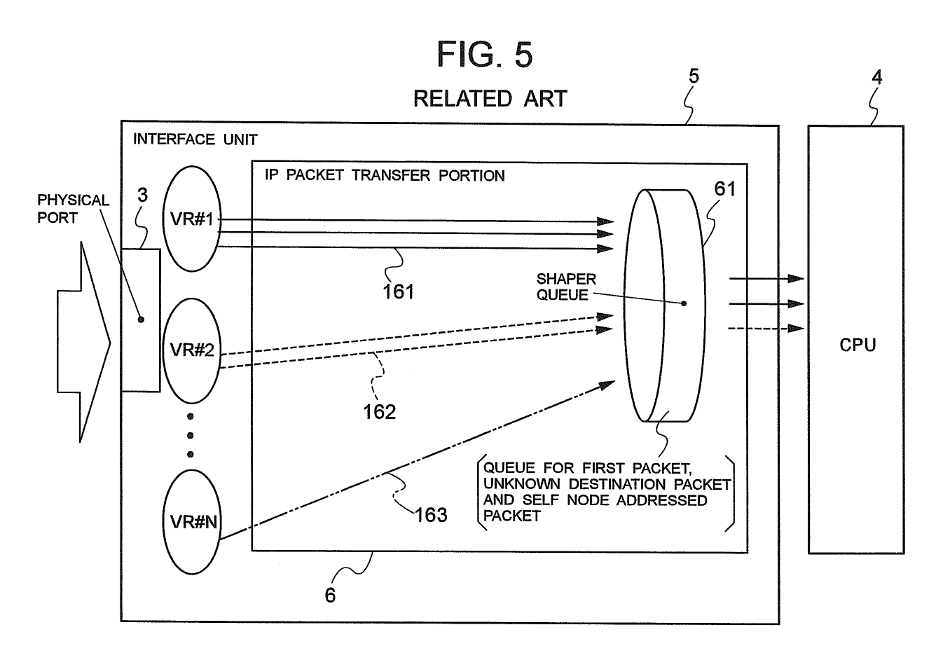

Referring to FIGS. 1 and 2, the operation of the layer 3 switch according to the first embodiment of the invention will be described below. Firstly, the flow rate control for the first packet addressed to the CPU by a general method will be described below using FIG. 5.

The first packets 161 to 163 entering an interface unit 5 are all sent out under the flow rate control by a shaper queue 61, irrespective of the virtual routers. As shown in FIG. 5, the first packets of the virtual routers VR#1 and VR#2 with relatively large flow rates are sent to the CPU 4, but the first packet 163 (chain double-dashed line) of the virtual router VR#N with a smaller flow rate is discarded. Accordingly, in the configuration of FIG. 5, the first packet of the virtual router with smaller flow rate is not sent to the CPU 4, whereby there is a bias in the first packet sending amount on each virtual router.

Referring to FIG. 1, the operation of the flow rate control for the first packet addressed to the CPU in the layer 3 switch according to the first embodiment of the invention will be described below.

The first packets 121 to 123 entering the interface unit 1 are firstly controlled for flow rate by the first shaper queues 22 to 24 provided corresponding to the virtual routers VR#1 to VR#N, respectively. Each of the first shaper queues 22 to 24 is a preset fixed length queue, in which the inflowing packet over this queue length is discarded, so that the flow rate control for each packet is performed for each of the virtual routers VR#1 to VR#N.

Thereafter, the second shaper queue 21 performs the scheduling by round robin method. That is, the sending bandwidth (flow rate of packet addressed to the CPU) of the second shaper queue 21 is dynamically controlled by the monitor control portion 7 in connection with the resource use state of the CPU 4. And the packet is sent under the flow rate control from the second shaper queue 21 to the CPU 4. Finally, the first packets 121 to 123 of the virtual routers VR#1 to VR#N are sent to the CPU 4 at the almost same rate.

Herein, the operation of the second shaper queue 21 will be described below in detail using FIG. 2. The second shaper queue 21 is placed in a normal state S1 as shown in FIG. 2, in the case of a normal CPU low load state. In this state, no congestion control is performed.

When the CPU use ratio becomes greater than or equal to N % (N<100%) from here, the second shaper queue 21 transits to the congestion state S2 (S4 of FIG. 2). In this state, the congestion control is performed. The congestion control is performed at every fixed period of time (second) by reviewing the flow rate control amount in accordance with the amount of packets to be processed by the CPU. Herein, if the CPU use ratio is always less than or equal to a certain value M % (M<N) for the fixed period of time (second), the operation transits to the normal state S1 (S5 of FIG. 2).

Conversely, if the CPU use ratio reaches 100% from the congestion state S2, the operation transits to the congestion state avoidance control state S3 (S6 of FIG. 2). In this state, (1) a large amount of first packets are controlled for flow rate, and (2) if the CPU use ratio is below R % (M<R<N), the flow rate (sending bandwidth) of the second shaper queue addressed to the CPU is increased. If the CPU gets into the congestion state again by increasing the flow rate addressed to the CPU, the operation returns to the processing (1). (3) If the CPU use ratio is always less than or equal to the certain value M % (M<N) for the fixed period of time (second), as in the congestion state S2, the operation transits to the normal state S1 (S7 of FIG. 2).

The congestion state avoidance control state S3 will be more specifically described below. If the operation gets into the congestion state S2, the flow rate for the second shaper queue 21 is narrowed, and at the same time the packets passing through the first shaper queues 22 to 24 from each virtual router VR are sequentially scheduled by round robin method in capturing the packets into the second shaper queue 21.

In this embodiment, the first shaper queues 22 to 24 assigned to the virtual routers VR#1 to VR#N control the flow rate of the first packet addressed to the CPU independently for the virtual routers VR#1 to VR#N, and the second shaper queue 21 dynamically performs the shaping control for the total sending bandwidth of the first packet addressed to the CPU, with its flow rate being controlled for each of the virtual routers VR#1 to VR#N, based on the CPU use ratio, whereby it is possible to reduce a bias in the first packet sending amount for each of the virtual routers VR#1 to VR#N, while avoiding the congestion of the CPU 4.

That is, the first shaper queues 22 to 24 can relieve the unfairness for each of the virtual routers VR, and the second shaper queue 21 can avoid the congestion state of the CPU.

### Second Exemplary Embodiment

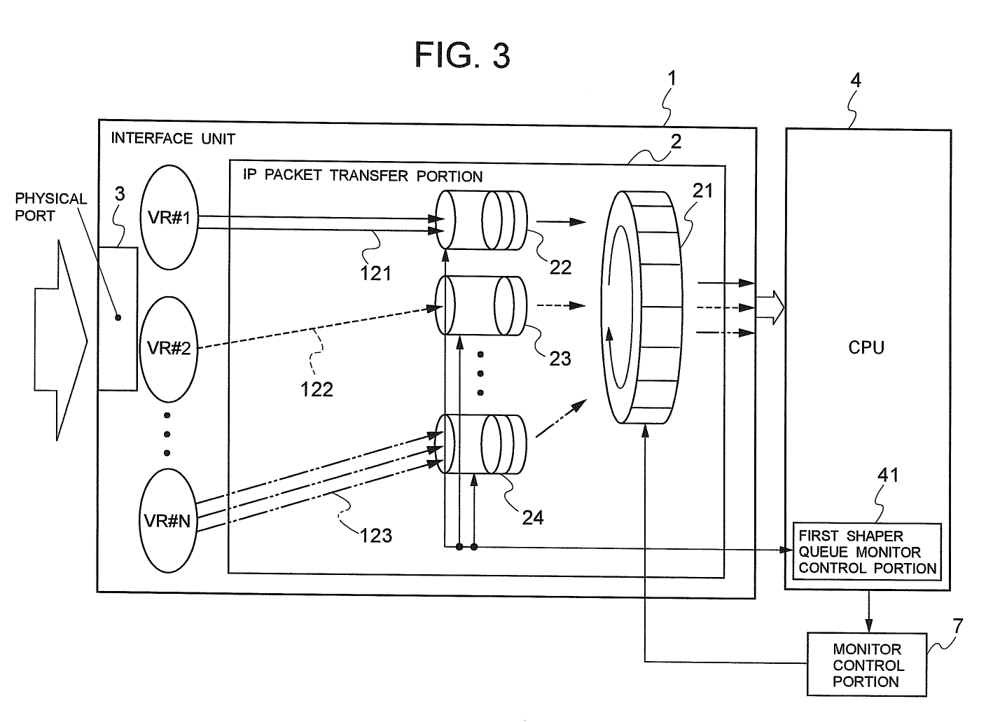

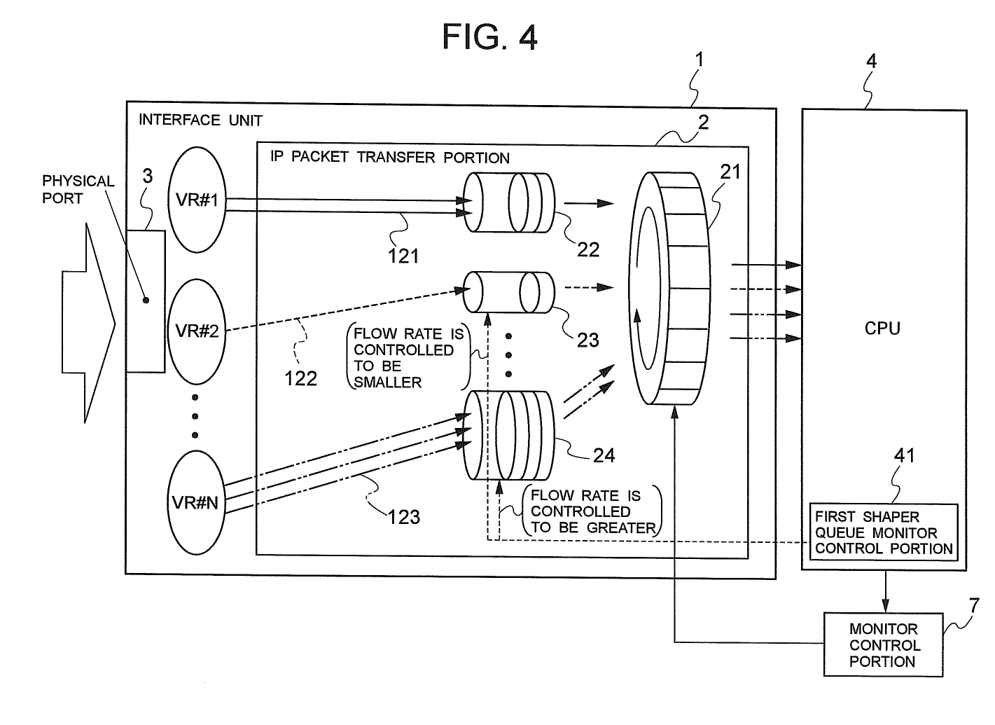

FIG. 3 is a diagram showing the configuration of a layer 3 switch according to a second exemplary embodiment of the invention and a state of the shaper queues inside. FIG. 4 is a view showing a flow state of the IP packets inside. In FIGS. 3 and 4, the same or like portions are designated by the same reference numerals as in FIG. 1.

In this embodiment, in addition to the configuration of FIG. 1, a first shaper queue monitor control portion 41 is provided inside the CPU 4. The first shaper queue monitor control portion 41 monitors the inflow rate (inflow rate per unit time) for each of the first shaper queues 22 to 24, and dynamically controls the flow rate into each of the first shaper queues 22 to 24, based on the monitor result. The other configuration is the same as the configuration of the first exemplary embodiment shown in FIG. 1.

In FIGS. 3 and 4, the flow of each IP packet is a first packet flow 121 of the virtual router VR#1, a first packet flow 122 of the virtual router VR#2, or a first packet flow 123 of the virtual router VR#N. The queues of the virtual routers VR#1 to VR#N include a first shaper queue 22 of the virtual router VR#1, a first shaper queue 23 of the virtual router VR#2, and a first shaper queue 24 of the virtual router VR#N.

Referring to FIGS. 3 and 4, the flow rate control operation of the first packet addressed to the CPU according to the second exemplary embodiment will be described below.

Referring firstly to FIG. 3, the first packets 121 to 123 entering the interface unit 1 are firstly controlled for flow rate by the first shaper queues 22 to 24 provided corresponding to the virtual routers VR#1 to VR#N. In this embodiment, the first shaper queue monitor control portion 41 in the CPU 4 monitors the inflow rate per unit time for the first shaper queues 22 to 24 for each of the virtual routers VR#1 to VR#N, and performs the flow rate control for each of the shaper queues 22 to 24 in accordance with the monitor result.

Referring to FIG. 4, the flow rate for the first shaper queue 23 for the virtual router VR#2 with less inflow rate of the first packet is decreased, and the flow rate for the first shaper queue 24 for the virtual router VR#N with more inflow rate of the first packet is increased. To control the flow rate, the queue length may be adjusted. For example, when the flow rate is decreased, the queue length is made smaller, or conversely when the flow rate is increased, the queue length is made greater.

In the embodiment, the inflow rate per unit time for each of the first shaper queues for each of the virtual routers VR is monitored, and the flow rate for the first shaper queue is controlled, based on the monitor result, whereby the greatly increased first packets can be supplied to the CPU for each of the virtual routers VR#1 to VR#N without discarding them.

The following procedure for the packets shaped in the first shaper queues 22 to 24 for each of the virtual routers VR#1 to VR#N is the same as the first embodiment of the invention shown in FIG. 1. That is, the first packets 121 to 123 are scheduled by round robin method in the second shaper queue 21, and sent to the CPU 4 in which the flow rate addressed to the CPU is dynamically controlled in connection with the resource use state of the CPU 4.

An exemplary advantage according to the invention has the effect that it is possible to send the first packet to the CPU without a bias for each virtual router (fairly), while avoiding the congestion (overload) state of the CPU.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A layer 3 switch device of a first packet system in which a first packet in the communication flow is sent via a packet transfer portion to header information retrieval portion of performing a retrieval process for the header information, comprising:
a plurality of first shaper queues, which are provided corresponding to a plurality of virtual routers, for performing a flow rate control for each first packet from said packet transfer portion to said header information retrieval portion;
a second shaper queue for performing a flow rate control for the first packet of which the flow rate is controlled in said plurality of first shaper queues; and
control portion for dynamically controlling the flow rate of packet from said second shaper queue to said header information retrieval portion in accordance with a load state in said header information retrieval portion.

2. The layer 3 switch device according to claim 1, wherein said second shaper queue makes a scheduling for the first packet by a round robin method.

3. The layer 3 switch device according to claim 1, further comprising control portion for dynamically controlling each inflow rate for said first shaper queues based on the monitor result of monitoring each flow rate for the first shaper queues from each of said virtual routers.

4. The layer 3 switch device according to claim 1, wherein said packet is an IP (Internet Protocol) packet.

5. A control method for a layer 3 switch device of a first packet system in which a first packet in the communication flow is sent via a packet transfer portion to header information retrieval portion of performing a retrieval process for the header information, comprising:
performing a flow rate control for the first packet from said packet transfer portion to said header information retrieval portion with a plurality of first shaper queues provided corresponding to a plurality of virtual routers;
performing a flow rate control for the first packet of which the flow rate is controlled in said plurality of first shaper queues using a second shaper queue; and
dynamically controlling the flow rate of packet from said second shaper queue to said header information retrieval portion in accordance with a load state in said header information retrieval portion.

6. The method according to claim 5, wherein said second shaper queue makes a scheduling for the first packet by a round robin method.

7. The method according to claim 5, further comprising dynamically controlling the flow rate for said first shaper queue based on the monitor result of monitoring the inflow rate for the first shaper queues from each of said virtual routers.

8. The method according to claim 5, wherein said packet is an IP (Internet Protocol) packet.

9. A layer 3 switch device of a first packet system in which a first packet in the communication flow is sent via a packet transfer means to header information retrieval means of performing a retrieval process for the header information, comprising:
a plurality of first shaper queues, which are provided corresponding to a plurality of virtual routers, for performing a flow rate control for each first packet from said packet transfer portion to said header information retrieval means;
a second shaper queue for performing a flow rate control for the first packet of which the flow rate is controlled in said plurality of first shaper queues; and
control means for dynamically controlling the flow rate of packet from said second shaper queue to said header information retrieval means in accordance with a load state in said header information retrieval means.
